(19) United States
(12) Patent Application Publication
(10) Pub. No.: US 2021/0051575 A1
(43) Pub. Date: Feb. 18, 2021

(54) SYSTEM INFORMATION UPDATING METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Ning Yang, Dongguan (CN); Cong Shi, Dongguan (CN); Xin You, Dongguan (CN)

(73) Assignee: GUANGDONG OPPO MOBILE TELECOMMUNICATIONS CORP., LTD., Dongguan (CN)

(21) Appl. No.: 17/088,462

(22) Filed: Nov. 3, 2020

Related U.S. Application Data
(63) Continuation of application No. PCT/CN2018/085715, filed on May 4, 2018.

(51) Int. Cl. H04W 48/16; H04W 72/04; H04W 48/10

(52) U.S. Cl. CPC H04W 48/16; H04W 48/10; H04W 72/04

(57) ABSTRACT

Embodiments of the present disclosure provide a system information updating method, a terminal device, and a network device. The terminal device can normally receive the updated system information during a BWP switch triggered by the terminal device, thereby ensuring that the terminal device can also update the system information during the BWP switch. The method includes: the terminal device triggers a switch from a first BWP to a second BWP; and the terminal device receives new system information on the first BWP, or receives new system information on the second BWP.

### CROSS-REFERENCE TO RELATED APPLICATIONS

This application is a continuation of International Application No. PCT/CN2018/085715, filed on May 4, 2018, which is hereby incorporated by reference in its entirety.

### TECHNICAL FIELD

Embodiments of the present disclosure relate to the field of communications, and in particularly, to a system information updating method, a terminal device, and a network device.

### BACKGROUND

In a new radio (NR) system, the terminal device may activate one or more bandwidth parts (BWP) after entering the connected state. At the same time, the BWP may or may not include system information. When the system information changes, the terminal device may obtain the latest system information through the currently resident BWP. If there is no system information in the currently resident BWP, the network device may send the updated system information to the terminal device through dedicated signaling. However, when the system information changes, the terminal device needs a certain amount of time to read the updated system information sent by broadcasting. During this process, if the network device instructs the terminal device to switch BWP (e.g., switch from BWP1 to BWP2), the terminal device cannot know how to receive the updated system information.

### SUMMARY

Embodiments of the present disclosure provide a system information updating method, a terminal device, and a network device. The terminal device can normally receive the updated system information during a BWP switch triggered by the terminal device, thereby ensuring that the terminal device can also update the system information during the BWP switch.

In a first aspect, a system information updating method is provided, including:

triggering, by a terminal device, a switch from a first BWP to a second BWP; and

receiving, by the terminal device, new system information on the first BWP, or receiving, by the terminal device, new system information on the second BWP.

Optionally, if the terminal device receives the new system information on the first BWP, the terminal device performs a BWP switch after receiving the new system information.

Optionally, if the terminal device receives the new system information on the second BWP, the terminal device receives the new system information after the BWP is switched.

Therefore, in embodiments of the present disclosure, when the terminal device triggers the BWP switch, the terminal device may receive the new system information on the first BWP that resides before the switch, or on the second BWP that resides after the switch, thereby ensuring that the terminal device may also update the system information during the BWP switch.

In some possible implementations, triggering, by the terminal device, the switch from the first BWP to the second BWP includes:

if an inactivity timer for the first BWP expires, triggering, by the terminal device, the switch from the first BWP to the second BWP.

Therefore, it may be that when the inactivity timer for the first BWP expires, the terminal device actively triggers the BWP switch, which avoids the signaling overhead generated by the network device indication.

In some possible implementations, triggering, by the terminal device, the switch from the first BWP to the second BWP includes:

receiving, by the terminal device, first indication information sent by a network device, where the first indication information is configured for indicating the terminal device to switch from the first BWP to the second BWP; and

triggering, by the terminal device, according to the first indication information, the switch from the first BWP to the second BWP.

Therefore, the terminal device may trigger BWP switch under the trigger of the network device indication.

In some possible implementations, the first indication information is radio resource control (RRC) signaling or downlink control information (DCI).

In some possible implementations, receiving, by the terminal device, the new system information on the first BWP includes:

after the new system information is received on the first BWP, switching, by the terminal device, from the first BWP to the second BWP.

In some possible implementations, receiving, by the terminal device, the new system information on the first BWP includes:

if the inactivity timer for the first BWP expires when the terminal device is receiving the new system information, starting or restarting, by the terminal device, the inactivity timer, and receiving the new system information on the first BWP.

In some possible implementations, receiving, by the terminal device, the new system information on the second BWP includes:

if there is no system information on the second BWP after the terminal device switches from the first BWP to the second BWP, automatically switching, by the terminal device, from the second BWP to a third BWP with system information, and receiving the new system information on the third BWP.

In some possible implementations, the third BWP is the first BWP or the initial BWP.

In some possible implementations, receiving, by the terminal device, the new system information on the second BWP includes:

receiving, by the terminal device, the new system information sent by a network device through a dedicated signaling or a broadcast message on the second BWP.

In some possible implementations, before receiving, by the terminal device, the new system information sent by the network device through the dedicated signaling or the broadcast message on the second BWP, the method further includes:

sending, by the terminal device, first information to the network device, where the first information indicates that the terminal device does not have the new system information, or that the terminal device does not have the complete new system information.

In some possible implementations, sending, by the terminal device, the first information to the network device includes:

before the terminal device switches to the second BWP according to the first indication information, sending, by the terminal device, the first information to the network device; or

after the terminal device switches to the second BWP according to the first indication information, sending, by the terminal device, the first information to the network device.

In some possible implementations, the first information is one of RRC signaling, media access control control element (MAC CE), or physical uplink shared channel (PUSCH) signaling.

In some possible implementations, receiving, by the terminal device, the new system information on the second BWP includes:

if there is no system information on the second BWP after the terminal device switches from the first BWP to the second BWP, performing, by the terminal device, re-establishment to a fourth BWP with system information, and receiving the new system information on the fourth BWP.

In some possible implementations, performing, by the terminal device, re-establishment to the fourth BWP with system information includes:

if the new system information is essential system information, performing, by the terminal device, re-establishment to the fourth BWP.

In some possible implementations, before performing, by the terminal device, re-establishment to the fourth BWP the method further includes:

sending, by the terminal device, a re-establishment message to the network device, where the re-establishment message indicates that a reason for the re-establishment is missing of system information.

In some possible implementations, before triggering, by the terminal device, the switch from the first BWP to the second BWP, the method further includes:

receiving, by the terminal device, second indication information sent by the network device on the first BWP, where the second indication information is configured for indicating the terminal device to update system information;

receiving, by the terminal device, the new system information on the first BWP, or receiving, by the terminal device, the new system information on the second BWP includes:

in response to the second indication information, receiving, by the terminal device, the new system information on the first BWP, or receiving, by the terminal device, the new system information on the second BWP.

In some possible implementations, the second indication information is paging information or downlink control information.

In some possible implementations, where the system information includes a master information block (MIB), a remaining system information (RMSI), and other system information blocks x (SIBx).

In a second aspect, a system information updating method is provided, including:

sending, by a network device, first indication information to a terminal device, where the first indication information is configured for triggering the terminal device to switch from a first BWP to a second BWP; and

sending, by the network device, new system information on the first BWP, or sending, by the network device, new system information on the second BWP.

Optionally, if the network device sends the new system information on the first BWP, the terminal device performs the BWP switch after receiving the new system information.

Optionally, if the network device sends the new system information on the second BWP, the terminal device receives the new system information after the BWP is switched.

Therefore, in embodiments of the present disclosure, when the terminal device triggers the BWP switch, the network device may send the new system information on the first BWP which resides on the terminal device before the switch, or on the second BWP which resides on the terminal device after the switch, thereby ensuring that the terminal device may also update the system information during the BWP switch.

In some possible implementations, the first indication information includes configuration information of an inactivity timer for the first BWP, and/or indication information indicating the terminal device to switch from the first BWP to the second BWP.

In some possible implementations, sending, by the network device, the new system information to the terminal device on the first BWP includes:

if the inactivity timer for the first BWP expires when the terminal device is receiving the new system information, sending, by the network device, the new system information to the terminal device on the first BWP after the inactivity timer is started or restarted by the terminal device.

In some possible implementations, sending, by the network device, the new system information to the terminal device on the second BWP includes:

sending, by the network device, the new system information to the terminal device on a third BWP, where the third BWP is a BWP with system information to which the terminal device automatically switches after the terminal device switches to the second BWP without system information according to the first indication information.

In some possible implementations, the third BWP is the first BWP or the initial BWP.

In some possible implementations, sending, by the network device, the new system information to the terminal device on the second BWP includes:

receiving, by the network device, first information sent by the terminal device, where the first information indicates that the terminal device does not have the new system information, or that the terminal device does not have the complete new system information; and

sending, by the network device, the new system information to the terminal device on the second BWP in response to the first information.

In some possible implementations, the first information is one of RRC signaling, MAC CE, and PUCCH signaling.

In some possible implementations, sending, by the network device, the new system information to the terminal device on the second BWP includes:

sending, by the network device, the new system information to the terminal device on the second BWP through a dedicated signaling or a broadcast message.

In some possible implementations, sending, by the network device, the new system information to the terminal device on the second BWP includes:

receiving, by the network device, a re-establishment message sent by the terminal device, where the re-establishment message indicates that a reason for re-establishment is missing of system information; and

sending, by the network device, the new system information to the terminal device on the fourth BWP, where the fourth BWP is the BWP with system information and performed re-establishment by the terminal device.

In some possible implementations, receiving, by the network device, the re-establishment message sent by the terminal device includes:

if the new system information is essential system information, receiving, by the network device, the re-establishment message sent by the terminal device.

In some possible implementations, before sending, by the network device, the first indication information to the terminal device, the method further includes:

sending, by the network device, second indication information to the terminal device, where the second indication information is configured for indicating the terminal device to update system information.

In some possible implementations, the second indication information is paging information or downlink control information.

In some possible implementations, the first indication information is RRC signaling or downlink control information.

In some possible implementations, the system information includes MIB, RMSI, and other SIBx.

In a third aspect, a terminal device is provided for performing the method in the above-mentioned first aspect or various implementations thereof.

Specifically, the terminal device includes a functional module for performing the method in the above-mentioned first aspect or various implementations thereof.

In a fourth aspect, a network device is provided for performing the method in the above-mentioned second aspect or various implementations thereof.

Specifically, the network device includes a functional module for performing the method in the above-mentioned second aspect or various implementations thereof.

In a fifth aspect, a terminal device is provided, including a processor and a memory. The memory is configured to store a computer program, and the processor is configured to call and run the computer program stored in the memory to execute the method in the above-mentioned first aspect or the various implementations thereof.

In a sixth aspect, a network device is provided, including a processor and a memory. The memory is configured to store a computer program, and the processor is configured to call and run the computer program stored in the memory to execute the method in the above-mentioned second aspect or various implementations thereof.

In a seventh aspect, a chip is provided for implementing the method in any one of the above-mentioned first to second aspects or various implementations thereof.

Specifically, the chip includes: a processor, configured to call and run a computer program from the memory, so that the device installed with the chip may execute the method in any one of the above-mentioned first to second aspects or various implementations thereof.

In an eighth aspect, a computer-readable storage medium is provided for storing a computer program that causes a computer to execute the method in any one of the above-mentioned first to second aspects or various implementations thereof.

In a ninth aspect, a computer program product is provided, including computer program instructions, which cause the computer to execute the method in any one of the above-mentioned first to second aspects or various implementations thereof.

In a tenth aspect, a computer program is provided, when run on a computer, causes a computer to execute the method in any one of the above-mentioned first to second aspects or the various implementations thereof.

In an eleventh aspect, a wireless communication system is provided, including a terminal device and a network device; where,

the terminal device is configured to: trigger a switch from the first BWP to the second BWP; receive new system information on the first BWP, or receive new system information on the second BWP;

the network device is configured to: send first indication information to the terminal device, where the first indication information is configured for triggering the terminal device to switch from the first BWP to the second BWP; send the new system information on the first BWP, or send the new system information on the second BWP.

Specifically, the terminal device is configured to execute the method in the above-mentioned first aspect or the various implementations thereof, and the network device is configured to execute the method in the above-mentioned second aspect or the various implementations thereof.

### BRIEF DESCRIPTION OF DRAWINGS

FIG. 1 is a schematic diagram of an application scenario of embodiments of the present disclosure.

FIG. 2 is a schematic diagram of BWP activation by RRC signaling according to an embodiment of the present disclosure.

FIG. 3 is a schematic diagram of BWP activation by DCI signaling according to an embodiment of the present disclosure.

FIG. 4 is a schematic diagram of a BWP according to an embodiment of the present disclosure.

FIG. 5 is a schematic flowchart of a system information updating method according to an embodiment of the present disclosure.

FIG. 6 is a schematic flowchart of a system information updating method according to another embodiment of the present disclosure.

FIG. 7 is a schematic block diagram of a terminal device according to an embodiment of the present disclosure.

FIG. 8 is a schematic block diagram of a network device according to an embodiment of the present disclosure.

FIG. 9 is a schematic block diagram of a communication device according to an embodiment of the present disclosure.

FIG. 10 is a schematic block diagram of a chip according to an embodiment of the present disclosure.

FIG. 11 is a schematic block diagram of a wireless communication system according to an embodiment of the present disclosure.

### DESCRIPTION OF EMBODIMENTS

The technical solutions in the present disclosure will be described below with reference to the accompanying drawings in embodiments of the present disclosure.

Embodiments of the present disclosure can be applied to various communication systems, for example: a global system of mobile communication (GSM) system, a code division multiple access (CDMA) system, and a wideband code division multiple access (WCDMA) system, a general packet radio service (GPRS), a long term evolution (LTE) system, an advanced long term evolution (LTE-A) system, an NR system, an evolutionary system of NR system, a LTE-based access to unlicensed spectrum (LTE-U) system, an NR-based access to unlicensed spectrum (NR-U) system, a universal mobile telecommunication system (UMTS), wireless local area networks (WLAN), wireless fidelity (WiFi), next-generation communication systems or other communication systems, etc.

In general, traditional communication systems support a limited number of connections and are easy to implement. However, with the development of communication technologies, mobile communication systems will not only support traditional communication, but also support, for example, device to device (D2D) communication, machine to machine (M2M) communication, machine type communication (MTC), and vehicle to vehicle (V2V) communication, etc. Embodiments of the present disclosure may also be applied to these communication systems.

Optionally, the communication system in embodiments of the present disclosure may be applied to a scenario of carrier aggregation (CA), a scenario of dual connectivity (DC), or a scenario of standalone (SA) web configuration.

Embodiments of the present disclosure do not limit the applied frequency spectrum. For example, embodiments of the present disclosure may be applied to licensed spectrum or unlicensed spectrum.

Embodiments of the present disclosure describe various embodiments in combination with a network device and a terminal device, where the terminal device may also be referred to as a user equipment (UE), an access terminal, a user unit, a user station, a mobile station, a mobile platform, a remote station, a remote terminal, a mobile device, a user terminal, a terminal, a wireless communication device, a user agent or a user device, etc. The terminal device may be a station (ST) in the WLAN, may be a cellular phone, a cordless phone, a session initiation protocol (SIP) phone, a wireless local loop (WLL) station, a personal digital assistant (PDA) device, a handheld device with wireless communication capabilities, a computing device, or other processing devices connected to wireless modems, an in-vehicle device, a wearable device, and next-generation communication systems, such as the terminal device in NR networks or the terminal device in the public land mobile network (PLMN) that will evolve in the future.

As an example and not a limitation, in embodiments of the present disclosure, the terminal device may also be a wearable device. Wearable devices can also be referred to as wearable smart devices, which are the general term for wearable devices developed by applying wearable technology to daily wearable intelligent design, such as glasses, gloves, watches, clothes, and shoes. A wearable device is a portable device that is worn directly on the body or integrated into the user's clothes or accessories. A wearable device is not only a hardware device, but also realizing powerful functions through software support, data interaction, and cloud interaction. Generalized wearable smart devices include devices of full-featured, large-sized, complete or partial functions that do not depend on smartphones, such as: smart watches or smart glasses, and devices only focus on a certain type of application functions, and need to cooperate with other devices such as smartphones to use, such as various smart bracelets and smart jewelry for signs monitoring.

The network device may be a device for communicating with a mobile device, and the network device may be an access point (AP) in WLAN, a base transceiver station (BTS) in GSM or CDMA, or a WCDMA NodeB (NB), may also be an evolutional Node B (eNB or eNodeB) in LTE, or a relay station or access point, or a vehicle-mounted device, a wearable device, and a network device (gNB) in an NR network or a network device in the PLMN network that might evolve in the future.

In embodiments of the present disclosure, the network device provides services for the cell, and the terminal device communicates with the network device through the transmission resources (e.g. frequency domain resources, or spectrum resources) used by the cell. The cell may be a cell corresponding to the network device (e.g. the base station) and may belong to a macro base station or a base station corresponding to a small cell. The small cell herein may include: a metro cell, a micro cell, and a pico cell, a femto cell, etc. These small cells have the characteristics of small coverage and low transmission power, and are suitable for providing high-speed data transmission services.

FIG. 1 exemplarily illustrates one network device and two terminal devices. Optionally, the wireless communication system 100 may include multiple network devices and there may be other numbers of terminal devices within the coverage area of each network device, which there is no limitation in embodiments of the present disclosure.

Optionally, the wireless communication system 100 may further include other network entities such as a mobility management entity (Mobility Management Entity, MME), an access and mobility management function (Access and Mobility Management Function, AMF), etc., which there is no limitation in embodiments of the present disclosure.

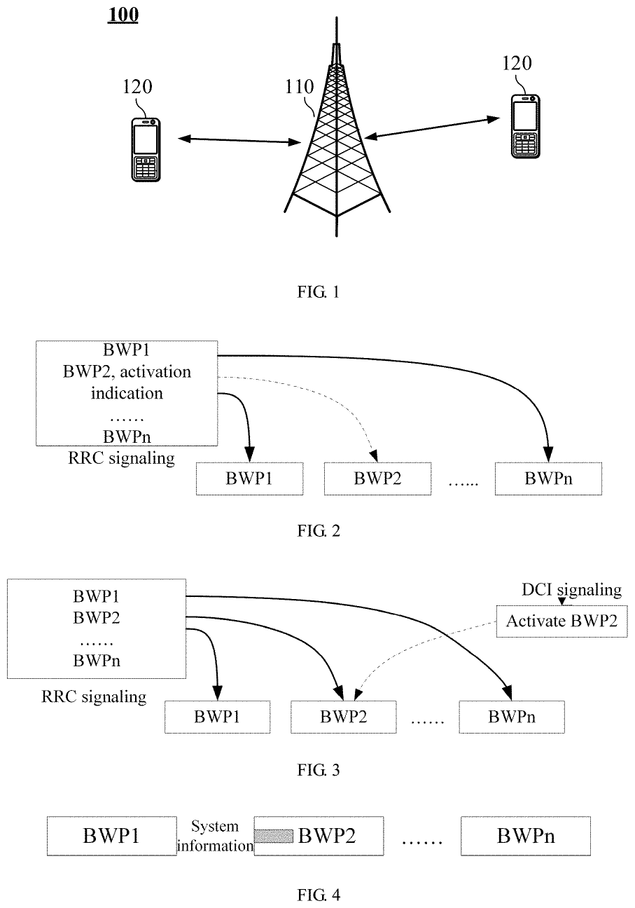

It should be understood that, in embodiments of the present disclosure, after entering the connected state, the terminal device will activate one or more BWPs. The activation method may be the RRC signaling activation method as shown in FIG. 2 or may be the DCI signaling activation method as shown in FIG. 3.

Specifically, the RRC signaling activation method may be: while configuring/reconfiguring the BWP through RRC signaling, the network device may indicate which BWP or which BWPs to be activated through the indication information. For example, as shown in FIG. 2, the RRC signaling configures/reconfigures BWP1, BWP2, BWPn, meanwhile, the RRC signaling indicates to activate BWP2, where n is a positive integer.

Specifically, the DCI signaling activation method may include: while configuring/reconfiguring the BWP through RRC signaling, the network device may indicate which BWP or which BWPs to be activated through the DCI signaling. For example, as shown in FIG. 3, the RRC signaling configures/reconfigures BWP1, BWP2, BWPn, meanwhile, the DCI signaling indicates to activate BWP2, where n is a positive integer.

It should be understood that, in embodiments of the present disclosure, the BWP may include system information or may not include system information. For example, as shown in FIG. 4, in BWP1, BWP2, BWPn, BWP2 includes system information, where n is a positive integer.

Furthermore, various aspects or features of the present disclosure may be implemented as methods, devices, or products using standard programming and/or engineering techniques. The term “products” used in the present disclosure encompasses a computer program accessible from any computer-readable device, carrier, or medium. For example, computer-readable media may include, but is not limited to: magnetic storage devices (e.g., hard disks, floppy disks, or magnetic tapes, etc.), optical disks (e.g., compact discs (CD), digital versatile discs (DVD) etc.), smart cards and flash memory devices (e.g., erasable programmable read-only memory (EPROM), cards, sticks or key drives, etc.). Furthermore, the various storage media described herein may represent one or more devices and/or other machine-readable media for storing information. The term “machine-readable media” may include, but is not limited to, various media capable of storing, containing, and/or carrying instructions and/or data.

It should be understood that the terms “system” and “network” are often used interchangeably herein. The term “and/or” herein is merely an association that describes associated objects, indicating that there may be three relationships. For example, A and/or B, which may mean: three cases of that A existing alone, A and B existing at the same time, B existing alone. Furthermore, the character “/” herein generally indicates that the related former and latter objects are in an “or” relationship.

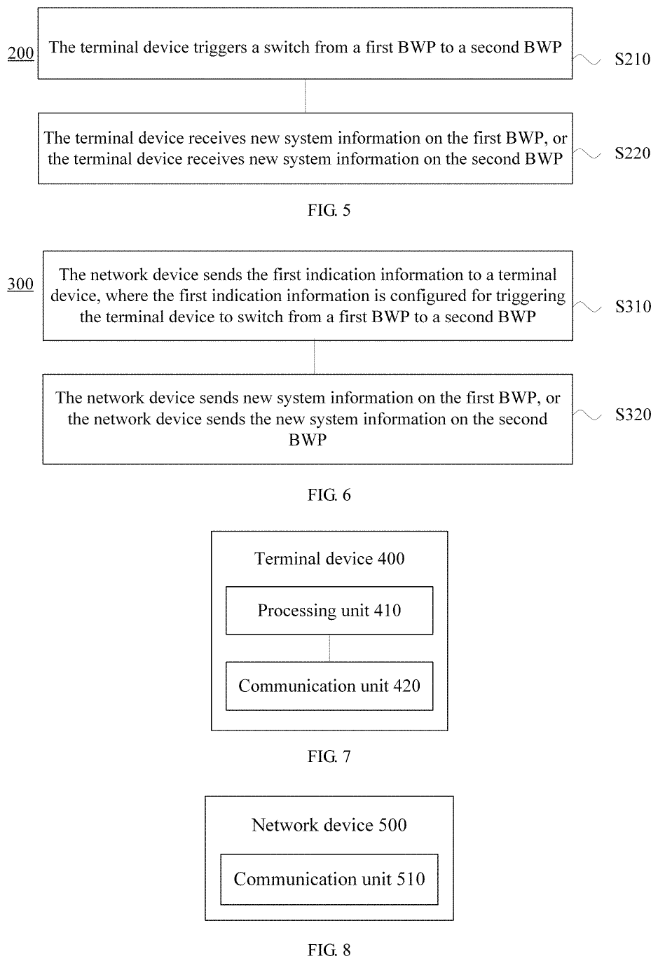

The system information updating method according to embodiments of the present disclosure will be described below with reference to FIGS. 5 to 6, and it should be understood that FIGS. 5 to 6 are schematic flowcharts of a system information updating method according to embodiments of the present disclosure, illustrating detailed communication steps or operations of the method, but these steps or operations are merely examples, and other operations or variations of various operations in FIGS. 5 to 6 may be performed in embodiments of the present disclosure, that is, there is no limitation of the orders of the steps in FIGS. 5 to 6 in embodiments of the present disclosure.

Furthermore, the steps in FIGS. 5 to 6 may be performed in a different order than that illustrated in FIGS. 5 to 6, and it may not be necessary to perform all the operations in FIGS. 5 to 6.

FIG. 5 is a schematic flowchart of system information updating 200 according to an embodiment of the present disclosure. The method 200 may be applied to the system shown in FIG. 1, but is not limited thereto. The method 200 includes at least part of the following content.

S210: The terminal device triggers a switch from a first BWP to a second BWP.

It should be understood that the terminal device currently resides on the first BWP. It may also be understood that the first BWP is currently in an activated state.

Optionally, the terminal device may trigger the switch from the first BWP to the second BWP in the following manner.

Manner 1: If an inactivity timer for the first BWP (BWP inactivity timer) expires, the terminal device triggers the switch from the first BWP to the second BWP.

It should be noted that the inactivity timer may be directed to the first BWP only, or may be directed to multiple BWPs including the first BWP at the same time.

Manner 2: The terminal device receives the first indication information sent by the network device, and the first indication information is configured for indicating the terminal device to switch from the first BWP to the second BWP;

the terminal device triggers the switch from the first BWP to the second BWP according to the first indication information.

Optionally, the first indication information is RRC signaling or downlink control information.

Optionally, before the terminal device triggers the switch from the first BWP to the second BWP, the method further includes:

the terminal device receives the second indication information sent by the network device on the first BWP, and the second indication information is configured for indicating the terminal device to update system information.

Optionally, the second indication information is paging information (paging) or downlink control information.

S220: The terminal device receives the new system information on the first BWP, or the terminal device receives the system information on the second BWP.

It should be noted that, if the terminal device receives the new system information on the first BWP, the terminal device performs BWP switch after the new system information is received. If the terminal device receives the new system information on the second BWP, the terminal device receives the new system information after the BWP is switched.

The new system information in embodiments of the present disclosure may include MIB, RMSI, and other system information blocks. It should be understood that RMSI may also be referred to as SIB1.

Optionally, after the new system information is received on the first BWP, the terminal device switches from the first BWP to the second BWP.

Specifically, the terminal device may receive the new system information on the first BWP under the following cases.

Case 1: The terminal device directly receives the new system information on the first BWP, and after the new system information is received on the first BWP, switches from the first BWP to the second BWP.

Case 2: If the inactivity timer for the first BWP expires when the terminal device is receiving the new system information, the terminal device starts or restarts the inactivity timer, and receives the new system information on the first BWP.

Specifically, the terminal device may receive the new system information on the second BWP under the following cases.

Case 1: if there is no system information on the second BWP after the terminal device switches from the first BWP to the second BWP, the terminal device automatically switches from the second BWP to a third BWP with system information, and receiving the new system information on the third BWP.

Optionally, the third BWP is the first BWP or the initial BWP.

It should be noted that, in Case 1, after switching to the second BWP, the terminal device first attempts to receive the new system information on the second BWP, however, the second BWP does not have system information. At this time, the terminal device automatically switches from the second BWP to a third BWP with system information, and receives the new system information on the third BWP.

Case 2: The terminal device receives the new system information sent by the network device through dedicated signaling or a broadcast message on the second BWP.

It should be noted that, in Case 2, the second BWP may or may not have system information. At this time, the terminal device only needs to receive the new system information sent by the network device through the dedicated signaling or the broadcast message on the second BWP.

Optionally, in Case 2, before the terminal device receives the new system information sent by the network device through the dedicated signaling or the broadcast message on the second BWP, the terminal device sends the first information to the network device, where the first information indicates that the terminal device does not have the new system information, or indicates that the terminal device does not have the complete new system information.

That is to say, the network device may actively send the new system information on the second BWP through the dedicated signaling or the broadcast message, or it may only send the new system information on the second BWP through the dedicated signaling or the broadcast message after the terminal device requests (i.e., after the terminal device sends the first information).

Optionally, in Case 2, before the terminal device switches to the second BWP according to the first indication information, the terminal device sends the first information to the network device; or after the terminal device switches to the second BWP according to the first indication information, the terminal device sends the first information to the network device.

Optionally, the first information is one of RRC signaling, MAC CE, and PUCCH signaling.

Case 3: after the terminal device switches from the first BWP to the second BWP, if there is no system information on the second BWP, the terminal device performs re-establishment to a fourth BWP with system information, and receives the new system information on the fourth BWP.

Optionally, in Case 3, if the new system information is essential system information (Essential SI), the terminal device performs re-establishment to the fourth BWP.

It should be noted that if the Essential SI is missing, the terminal device in the connected state cannot continue to maintain the access statum (AS) connection and/or bear configuration, and the terminal device may trigger a radio link failure (RLF) to perform re-establishment to the BWP with the cell defining synchronization signal block (CD-SSB).

Optionally, in Case 3, before the terminal device preforms re-establishment to the fourth BWP, the terminal device sends a re-establishment message to the network device, the re-establishment message indicates that the reason for the re-establishment is missing of system information.

It should be noted that if the terminal device receives the second indication information sent by the network device before the terminal device triggers the switch from the first BWP to the second BWP, in response to the second indication information, the terminal device receives the new system information on the first BWP, or the terminal device receives the new system information on the second BWP.

Therefore, in embodiments of the present disclosure, when the terminal device triggers a BWP switch, the terminal device may receive the new system information on the first BWP on which resides before the switch, or the second BWP on which resides after the switch, thereby ensuring that the terminal device can also update the system information during the BWP switch.

FIG. 6 is a schematic flowchart of a system information updating 300 according to an embodiment of the present disclosure. The method 300 may be applied to the system shown in FIG. 1, but is not limited thereto. The method 300 includes at least part of the following content.

S310: The network device sends the first indication information to the terminal device, where the first indication information is configured for triggering the terminal device to switch from the first BWP to the second BWP.

Optionally, the first indication information is RRC signaling or downlink control information.

Optionally, the first indication information includes configuration information of an inactivity timer for the first BWP, and/or indication information indicating the terminal device to switch from the first BWP to the second BWP.

S320: The network device sends the new system information on the first BWP, or the network device sends the new system information on the second BWP.

Optionally, the system information includes MIB, RMSI, and SIBx.

Optionally, the network device sends the new system information to the terminal device on the first BWP includes:

if the inactivity timer of the first BWP expires when the terminal device is receiving the new system information, the network device sends the new system information to the terminal device on the first BWP after the inactivity timer is started or restarted by the terminal device.

Optionally, the network device sends the new system information to the terminal device on the second BWP includes:

the network device sends the new system information to the terminal device on a third BWP, where the third BWP is a BWP with system information to which the terminal device automatically switches after the terminal device switches to the second BWP without system information according to the first indication information.

Optionally, the third BWP is the first BWP or the initial BWP.

Optionally, the network device sends the new system information to the terminal device on the second BWP includes:

the network device receives the first information sent by the terminal device, where the first information indicates that the terminal device does not have the new system information, or indicates that the terminal device does not have the complete new system information;

the network device sends the new system information to the terminal device on the second BWP in response to the first information.

Optionally, the first information is one of RRC signaling, MAC CE, and PUCCH signaling.

Optionally, the network device sends the new system information to the terminal device on the second BWP includes:

the network device sends the new system information to the terminal device on the second BWP through a dedicated signaling or a broadcast message.

Optionally, the network device sends the new system information to the terminal device on the second BWP includes:

the network device receives the re-establishment message sent by the terminal device, where the re-establishment message indicates that the reason for the re-establishment is missing of system information;

the network device sends the new system information to the terminal device on the fourth BWP, and the fourth BWP is a BWP with system information to which the terminal device performs the re-establishment.

Optionally, the network device receives the re-establishment message sent by the terminal device includes:

if the new system information is essential system information, the network device receives the re-establishment message sent by the terminal device.

Optionally, before the network device sends the first indication information to the terminal device, the method further includes:

the network device sends the second indication information to the terminal device, where the second indication information is configured for indicating the terminal device to update the system information.

Optionally, the second indication information is paging information or downlink control information.

It should be understood that, for the steps in the system information updating method 300 may be referred to the corresponding steps in the system information updating method 200. For brevity, details are not described herein.

Therefore, in the embodiment of the present disclosure, when the terminal device triggers the BWP switch, the network device may send the new system information on the first BWP where the terminal device resides before the switch, or on the second BWP where the terminal device resides after the switch, so that it can be ensured that the terminal device may also update the system information during the BWP switch.

FIG. 7 is a schematic block diagram of a terminal device 400 according to an embodiment of the present disclosure. As shown in FIG. 7, the terminal device 400 includes:

the processing unit 410, configured to trigger a switch from a first BWP to a second BWP;

the communication unit 420, configured to receive the new system information on the first BWP, or receive the new system information on the second BWP.

Optionally, the processing unit 410 is specifically configured to:

trigger the switch from the first BWP to the second BWP if an inactivity timer for the first BWP expires.

Optionally, the processing unit 410 is specifically configured to:

control the communication unit to receive the first indication information sent by the network device, where the first indication information is configured for indicating the terminal device to switch from the first BWP to the second BWP;

trigger the switch from the first BWP to the second BWP according to the first indication information.

Optionally, the first indication information is RRC signaling or downlink control information.

Optionally, the communication unit 420 is specifically configured to:

switch from the first BWP to the second BWP after the new system information is received on the first BWP.

Optionally, the communication unit 420 is specifically configured to:

trigger the processing unit to start or restart the inactivity timer if the inactivity timer of the first BWP expires when receiving the new system information, and receive the new system information on the first BWP.

Optionally, the communication unit 420 is specifically configured to:

if there is no system information on the second BWP after the terminal device switches from the first BWP to the second BWP, trigger the processing unit to control the terminal device to automatically switch from the second BWP to a third BWP with system information, and receive the new system information on the third BWP.

Optionally, the third BWP is the first BWP or the initial BWP.

Optionally, the communication unit 420 is specifically configured to:

receive the new system information sent by the network device through a dedicated signaling or a broadcast messages on the second BWP.

Optionally, before the communication unit 420 receives the new system information sent by the network device through the dedicated signaling or the broadcast message on the second BWP, the communication unit 420 is also configured to:

send first information to the network device, where the first information indicates that the terminal device does not have the new system information, or that the terminal device does not have the complete new system information.

Optionally, the communication unit 420 is specifically configured to:

send the first information to the network device before the terminal device switches to the second BWP according to the first indication information; or send the first information to the network device after the terminal device switches to the second BWP according to the first indication information.

Optionally, the first information is one of RRC signaling, MAC CE, and PUCCH signaling.

Optionally, the communication unit 420 is specifically configured to:

if there is no system information on the second BWP after the terminal device switches from the first BWP to the second BWP, trigger the processing unit to control the terminal device to perform re-establishment to a fourth BWP with system information, and receive the new system information on the fourth BWP.

Optionally, the processing unit 410 is specifically configured to:

control the terminal device 400 to be reconstructed to the fourth BWP if the new system information is the essential system information.

Optionally, before the processing unit 410 controls the terminal device to re-establish to the fourth BWP, the communication unit 420 is further configured to:

send a re-establishment message to the network device, where the re-establishment message indicates that the reason for the re-establishment is missing of system information.

Optionally, before the processing unit 410 triggers the switch from the first BWP to the second BWP, the communication unit 420 is further configured to:

receive the second indication information sent by the network device on the first BWP, where the second indication information is configured for indicating the terminal device to update the system information;

receive the new system information on the first BWP, or receive the new system information on the second BWP in response to the second indication information.

Optionally, the second indication information is paging information or downlink control information.

Optionally, the system information includes MIB, RMSI, and SIBx.

It should be understood that the above and other operations and/or functions of each module in the terminal device 400 according to embodiments of the present disclosure are respectively for implementing the corresponding processes of the terminal device in the method 200 in FIG. 5, and for brevity, details are not described herein.

FIG. 8 is a schematic block diagram of a network device 500 according to an embodiment of the present disclosure. As shown in FIG. 8, the network device 500 includes:

a communication unit 510, configured to send the first indication information to the terminal device, where the first indication information is configured for triggering the terminal device to switch from the first BWP to the second BWP;

the communication unit 510 is further configured to send the new system information on the first BWP, or send the new system information on the second BWP.

Optionally, the first indication information includes the configuration information of an inactivity timer for the first BWP, and/or the indication information indicating the terminal device to switch from the first BWP to the second BWP.

Optionally, the communication unit 510 is specifically configured to:

send the new system information to the terminal device on the first BWP after the inactivity timer is started or restarted by the terminal device if the inactivity timer for the first BWP expires when the terminal device is receiving new system information.

Optionally, the communication unit 510 is specifically configured to:

send the new system information to the terminal device on the third BWP, where the third BWP is a BWP with system information to which the terminal device automatically switches after the terminal device switches to the second BWP without system information according to the first indication information.

Optionally, the third BWP is the first BWP or the initial BWP.

Optionally, the communication unit 510 is specifically configured to:

receive the first information sent by the terminal device, where the first information indicates that the terminal device does not have the new system information, or indicating that the terminal device does not have the complete new system information;

send the new system information to the terminal device on the second BWP in response to the first information.

Optionally, the first information is one of RRC signaling, MAC CE, and PUCCH signaling.

Optionally, the communication unit 510 is specifically configured to:

send the new system information to the terminal device on the second BWP through the dedicated signaling or the broadcast message.

Optionally, the communication unit 510 is specifically configured to:

receive a re-establishment message sent by the terminal device, where the re-establishment message indicates that the reason of the re-establishment is missing of system information;

send the new system information to the terminal device on the fourth BWP, where the fourth BWP is a BWP with system information to which the terminal device performs the re-establishment.

Optionally, the communication unit 510 is specifically configured to:

receive the re-establishment message sent by the terminal device if the new system information is essential new system.

Optionally, before the communication unit 510 sends the first indication information to the terminal device, the communication unit is also configured to send the second indication information to the terminal device, where the second indication information is configured for indicating the terminal device to update the system information.

Optionally, the second indication information is paging information or downlink control information.

Optionally, the first indication information is RRC signaling or downlink control information.

Optionally, the system information includes MIB, RMSI, and SIBx.

It should be understood that the above and other operations and/or functions of each module in the network device 500 according to embodiments of the present disclosure are respectively for implementing the corresponding processes of the network device in the method 300 in FIG. 6, and for brevity, details are not described herein.

FIG. 9 is a schematic block diagram of a communication device 600 according to an embodiment of the present disclosure. The communication device 600 shown in FIG. 9 includes a processor 610, and the processor 610 may call and run a computer program from the memory to implement the method in embodiments of the present disclosure.

Optionally, as shown in FIG. 9, the communication device 600 may further include a memory 620. The processor 610 may call and run a computer program from the memory 620 to implement the method in embodiments of the present disclosure.

The memory 620 may be a separate device independent of the processor 610, or may be integrated in the processor 610.

Optionally, as shown in FIG. 9, the communication device 600 may further include a transceiver 630, and the processor 610 may control the transceiver 630 to communicate with other devices, specifically, may send information or data to other devices, or receive information or data sent by other devices.

Among others, the transceiver 630 may include a transmitter and a receiver. The transceiver 630 may further include antennas, and the number of antennas may be one or more.

Optionally, the communication device 600 may be the network device of embodiments of the present disclosure, and the communication device 600 may implement the corresponding process implemented by the network device in each method of embodiments of the present disclosure. For brevity, details are not described herein.

Optionally, the communication device 600 may be the terminal device of embodiments of the present disclosure, and the communication device 600 may implement the corresponding process implemented by the terminal device in each method of the embodiment of the present disclosure. For brevity, details are not described herein.

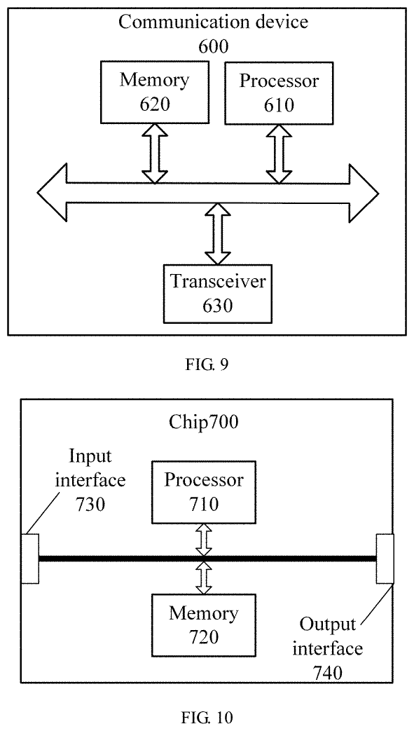

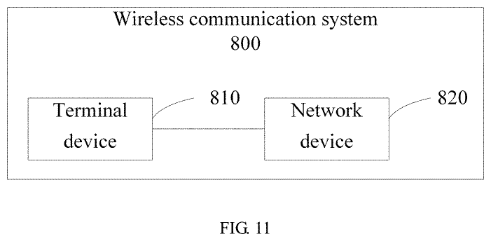

FIG. 10 is a schematic block diagram of a chip 700 according to an embodiment of the present disclosure. The chip 700 shown in FIG. 10 includes a processor 710, and the processor 710 may call and run a computer program from the memory to implement the method in embodiments of the present disclosure.

Optionally, as shown in FIG. 10, the chip 700 may further include a memory 720. The processor 710 may call and run a computer program from the memory 720 to implement the method in embodiments of the present disclosure.

The memory 720 may be a separate device independent of the processor 710, or may be integrated in the processor 710.

Optionally, the chip 700 may further include an input interface 730. The processor 710 may control the input interface 730 to communicate with other devices or chips. Specifically, it may obtain information or data sent by other devices or chips.

Optionally, the chip 700 may further include an output interface 740. The processor 710 can control the output interface 740 to communicate with other devices or chips. Specifically, it may output information or data to other devices or chips.

Optionally, the chip may be applied to the network device in embodiments of the present disclosure, and the chip may implement the corresponding process implemented by the network device in each method of embodiments of the present disclosure. For brevity, details are not described herein.

Optionally, the chip may be applied to the terminal device in embodiments of the present disclosure, and the chip may implement the corresponding process implemented by the terminal device in each method of embodiments of the present disclosure. For brevity, details are not described herein.

It should be understood that the chips mentioned in embodiments of the present disclosure may also be referred to as system-level chips, system chips, chip systems, or system-on-chip chips.

The processors mentioned above may be a general-purpose processor, a digital signal processor (DSP), a field programmable gate array (FPGA), an application specific integrated circuit (ASIC), or other programmable logic devices, transistor logic devices, discrete hardware components, etc. Where, the above-mentioned general-purpose processors may be a microprocessor or any conventional processor and the like.

The above-mentioned memories may be a volatile memory or a non-volatile memory, or may include both volatile and non-volatile memory. Where, the non-volatile memories may be a read-only memory (ROM), a programmable ROM (PROM), an erasable PROM (EPROM), an electrically EPROM (EEPROM) or flash memory. The volatile memory may be a random access memory (random access memory, RAM).

It should be understood that the foregoing memory is exemplary but not limiting, for example, the memories in embodiments of the present disclosure may also be a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM) and a direct rambus RAM (DR RAM), etc. That is to say, the memories in embodiments of the present disclosure are intended to include but are not limited to these and any other suitable types of memories.

FIG. 11 is a schematic block diagram of a wireless communication system 800 according to an embodiment of the present disclosure. As shown in FIG. 11, the wireless communication system 800 includes a terminal device 810 and a network device 820. The terminal device 810 is configured to trigger a switch from a first BWP to a second BWP; receive the new system information on the first BWP, or receive the new system information on the second BWP. The network device 820 is configured to send the first indication information to the terminal device, where the first indication information is configured for triggering the terminal device to switch from the first BWP to the second BWP; send the new system information on the first BWP, or, send the new system information on the second BWP.

Among others, the terminal device 810 may be configured to implement the corresponding functions implemented by the terminal device in the above method 200, and the composition of the terminal device 810 may be as the same as the terminal device 400 shown in FIG. 7. For brevity, details are not described herein.

The network device 820 may be configured to implement the corresponding functions implemented by the network device in the above method 300, and the composition of the network device 820 may be as the same as the network device 500 shown in FIG. 8. For brevity, details are not described herein.

In the above embodiments, it can be implemented in whole or in part by software, hardware, firmware, or any combination thereof. When implemented by using software, it can be implemented in whole or in part in the form of a computer program product. The computer program product includes one or more computer instructions. When the computer program instructions are loaded and executed on the computer, all or part of the processes or functions described in embodiments of the present disclosure are generated. The computer may be a general-purpose computer, a dedicated computer, a computer network, or other programmable devices. The computer instructions may be stored in a computer-readable storage medium, or transmitted from one computer-readable storage medium to another computer-readable storage medium, for example, the computer instructions may be from a website site, computer, server or data center via wired (e.g., coaxial cable, optical fiber, digital subscriber line (DSL)) or wireless (e.g., infrared, wireless, microwave, etc.) to another website, computer, server or data center. The computer-readable storage medium may be any available medium that can be accessed by a computer or data storage devices of integrated servers, data centers and the like that includes one or more available medium. The available medium may be a magnetic medium (e.g., a floppy disk, a hard disk, a magnetic tape), an optical medium (e.g., a DVD), or a semiconductor medium (e.g., a solid state disk (SSD)).

It should be understood that in various embodiments of the present disclosure, the numerical size of the sequence numbers of the above processes does not mean the order of execution, and the execution order of each process should be determined by its function and inherent logic, and there should be no limitation to the implementation processes applied to embodiments of the present disclosure.

Persons skilled in the art can clearly understand that for the convenience and conciseness of the description, the specific working process of the system, device and unit described above can refer to the corresponding process in the foregoing method embodiments, which will not be repeated herein.

The above is only the specific implementation of the present disclosure, but the scope of protection of this application is not limited to this, and persons skilled in the art may easily think of changes or substitutions within the technical scope disclosed in the present disclosure, which should all fall within the protection scope of the present disclosure. Therefore, the protection scope of the present disclosure shall be subject to the protection scope of the claims.

What is claimed is:

1. A system information updating method, comprising:
triggering, by a terminal device, a switch from a first bandwidth part (BWP) to a second BWP; and
receiving, by the terminal device, new system information on the first BWP, or receiving, by the terminal device, new system information on the second BWP.

2. The method according to claim 1, wherein triggering, by the terminal device, the switch from the first BWP to the second BWP comprises:
if an inactivity timer for the first BWP expires, triggering, by the terminal device, the switch from the first BWP to the second BWP.

3. The method according to claim 1, wherein triggering, by the terminal device, the switch from the first BWP to the second BWP comprises:
receiving, by the terminal device, first indication information sent by a network device, wherein the first indication information is configured for indicating the terminal device to switch from the first BWP to the second BWP; and
triggering, by the terminal device, according to the first indication information, the switch from the first BWP to the second BWP.

4. The method according to claim 1, wherein receiving, by the terminal device, the new system information on the first BWP comprises:
after the new system information is received on the first BWP, switching, by the terminal device, from the first BWP to the second BWP.

5. The method according to claim 1, wherein receiving, by the terminal device, the new system information on the first BWP comprises:
if an inactivity timer for the first BWP expires when the terminal device is receiving the new system information, starting or restarting, by the terminal device, the inactivity timer, and receiving the new system information on the first BWP.

6. The method according to claim 1, wherein receiving, by the terminal device, the new system information on the second BWP comprises:
if there is no system information on the second BWP after the terminal device switches from the first BWP to the second BWP, automatically switching, by the terminal device, from the second BWP to a third BWP with system information, and receiving the new system information on the third BWP; wherein the third BWP is the first BWP or the initial BWP.

7. The method according to claim 1, wherein receiving, by the terminal device, the new system information on the second BWP comprises:
receiving, by the terminal device, the new system information sent by a network device through a dedicated signaling or a broadcast message on the second BWP.

8. The method according to claim 7, wherein before receiving, by the terminal device, the new system information sent by the network device through the dedicated signaling or the broadcast message on the second BWP, the method further comprises:
sending, by the terminal device, first information to the network device, wherein the first information indicates that the terminal device does not have the new system information, or that the terminal device does not have the complete new system information.

9. The method according to claim 1, wherein receiving, by the terminal device, the new system information on the second BWP comprises:
if there is no system information on the second BWP after the terminal device switches from the first BWP to the second BWP, performing, by the terminal device, re-establishment to a fourth BWP with system information, and receiving the new system information on the fourth BWP.

10. The method according to claim 9, wherein performing, by the terminal device, re-establishment to the fourth BWP with system information comprises:
if the new system information is essential system information, performing, by the terminal device, re-establishment to the fourth BWP; wherein before performing, by the terminal device, re-establishment to the fourth BWP, the method further comprises:
sending, by the terminal device, a re-establishment message to a network device, wherein the re-establishment message indicates that a reason for the re-establishment is missing of system information.

11. A terminal device, comprising a processor, wherein the processor calls and runs a computer program from a memory to:
trigger a switch from a first bandwidth part (BWP) to a second BWP; and
receive new system information on the first BWP, or receive new system information on the second BWP.

12. The terminal device according to claim 11, wherein the processor further calls and runs a computer program from the memory to:
trigger the switch from the first BWP to the second BWP if an inactivity timer for the first BWP expires.

13. The terminal device according to claim 11, wherein the processor further calls and runs a computer program from the memory to:
receive first indication information sent by a network device, wherein the first indication information is configured for indicating the terminal device to switch from the first BWP to the second BWP; and
trigger the switch from the first BWP to the second BWP according to the first indication information.

14. The terminal device according to claim 11, wherein the processor further calls and runs a computer program from the memory to:
switch from the first BWP to the second BWP after the new system information is received on the first BWP.

15. The terminal device according to claim 11, wherein the processor further calls and runs a computer program from the memory to:
start or restart an inactivity timer, and receive the new system information on the first BWP, the inactivity timer for the first BWP expires when receiving the new system information.

16. The terminal device according to claim 11, wherein the processor further calls and runs a computer program from the memory to:
if there is no system information on the second BWP after the terminal device switches from the first BWP to the second BWP, control the terminal device to automatically switch from the second BWP to a third BWP with system information, and receive the new system information on the third BWP; wherein the third BWP is the first BWP or the initial BWP.

17. The terminal device according to claim 11, wherein the processor further calls and runs a computer program from the memory to:
receive the new system information sent by a network device through a dedicated signaling or a broadcast message on the second BWP.

18. The terminal device according to claim 17, wherein before the processor receives the new system information sent by the network device through the dedicated signaling or the broadcast message on the second BWP, the processor further calls and runs a computer program from the memory to:
send first information to the network device, wherein the first information indicates that the terminal device does not have the new system information, or that the terminal device does not have the complete new system information.

19. The terminal device according to claim 11, wherein the processor further calls and runs a computer program from the memory to:
if there is no system information on the second BWP after the terminal device switches from the first BWP to the second BWP, control the terminal device to perform re-establishment to a fourth BWP with system information, and receive the new system information on the fourth BWP.

20. The terminal device according to claim 19, wherein the processor further calls and runs a computer program from the memory to:
control the terminal device to perform the re-establishment to the fourth BWP if the new system information is essential system information;
wherein before the processor controls the terminal device to perform the re-establishment to the fourth BWP, the processor further calls and runs a computer program from the memory to:
send a re-establishment message to a network device, wherein the re-establishment message indicates that a reason for the re-establishment is missing of system information.
